(19) United States
(12) Patent Application Publication
(10) Pub. No.: US 2025/0114978 A1
(43) Pub. Date: Apr. 10, 2025

(54) INTEGRATED ANALYSIS AND OPTIMISATION OF A MECHANICAL POLYOLEFIN RECYCLING PROCESS

(71) Applicant: BOREALIS AG, Vienne (AT)

(72) Inventors: Susana Lopes Filipe, Évora (PT); Andreas Nagl, Linz (AT); Tuan Anh Tran, Linz (AT); Christian Goetzloff, Linz (AT); Doris Machl, Linz (AT); Mithun Goswami, Linz (AT)

(21) Appl. No.: 18/728,540

(22) PCT Filed: Jan. 19, 2023
(86) PCT No.: PCT/EP2023/051214

§ 371 Date: Jul. 12, 2024

(30) Foreign Application Priority Data
Jan. 21, 2022 (EP) 22152719.5

(51) Int. Cl. B29B 17/02; B29B 17/04; B29K 23/00; G05B 13/02; G05B 13/04

(52) U.S. Cl. CPC B29B 17/02; B29B 17/04; G05B 13/0265; G05B 13/042; B29B 2017/0203; B29B 2017/0224; B29B 2017/0289; B29B 2017/0293; B29B 2017/046; B29K 2023/00

(57) ABSTRACT

A process for collecting and storing quality control data in a mechanical polyolefin recycling process, a process for optimising the performance of the mechanical polyolefin recycling process in response to said quality control data, an adjustment control model and a use of quality control data for optimising the performance of the mechanical polyolefin recycling process.

The present invention relates to a process for collecting and storing quality control data in a mechanical polyolefin recycling process, a process for optimising the performance of the mechanical polyolefin recycling process in response to said quality control data, an adjustment control model and a use of quality control data for optimising the performance of the mechanical polyolefin recycling process.

### BACKGROUND TO THE INVENTION

During the last decade, concern about plastics and the environmental sustainability of their use in current quantities has grown. This has led to new legislation on disposal, collection and recycling of polyolefins. There have additionally been efforts in a number of countries to increase the recycling quota of plastic materials instead of energy recovery/incineration or landfilling.

In Europe, plastic waste accounts for approximately 27 million tons of waste a year; of this amount in 2016, 7.4 million tons were disposed of in landfill, 11.27 million tons were burnt (in order to produce energy) and around 8.5 million tons were recycled. Polypropylene based materials are a particular problem as these materials are extensively used in packaging. Taking into account the huge amount of waste collected compared to the amount of waste recycled back into the stream (amounting to only about 30%), there is still a great potential for intelligent reuse of plastic waste streams and for mechanical recycling of plastic wastes.

This invention particularly focuses on mechanically recycled waste streams as opposed to “energetic recycling” where polyolefins are burnt and used for energy or other forms of recycling such as chemical recycling and solvent-based recycling. However, due to cost reasons, poor mechanical properties and inferior processing properties waste streams containing cross-linked polyolefins are often used for energy recovery (e.g. incineration in a district heating plant or for heat generation in the cement industry) and are less often recycled into new products.

One major trend in the field of polyolefins is the use of recycled materials that are derived from a wide variety of sources. Durable goods streams such as those derived from waste electrical equipment (WEE) or end-of-life vehicles (ELV) contain a wide variety of plastics. These materials can be processed to recover acrylonitrile-butadiene-styrene (ABS), high impact polystyrene (HIPS), polypropylene (PP) and polyethylene (PE) plastics. Separation can be carried out using density separation in water and then further separation based on fluorescence, near infrared absorption or Raman spectroscopy.

The better the quality, i.e. the higher the purity, of the recycled polyolefin the more expensive the material is. Moreover, recycled polyolefin materials are often cross-contaminated with non-polyolefin materials, such as polyethylene terephthalate, polyamide, polystyrene or non-polymeric substances like wood, paper, glass or aluminium.

In addition, recycled polyolefin rich materials often have properties much worse than those of the virgin materials, unless the amount of recycled polyolefin added to the final compound is extremely low.

Mechanical polyolefin recycling processes typically comprise a number of constituent steps, such as washing, shredding, sorting and in some cases aerating, as well as optionally compounding/extrusion to form pellets of recycled material. Each of these steps is typically used to improve one or more property of the final recycled polyolefin. For example, sorting can remove materials other than the desired polyolefin and washing can remove contaminants from the surface of articles/flakes.

Whilst each of these constituent steps is generally used to target a certain issue, none of the steps operate in isolation. For example, improved sorting may have the effect of reducing odour, a task that is usually associated with washing and/or aeration steps. This additional effect comes about by avoiding any materials, such as polystyrene or PVA that may decompose in later steps and contribute to the odour of the recycled polyolefin.

As such, the interplay between the various constituent steps is more complicated than many perceive.

In the art, the properties of the recycled polyolefin are generally measured, in order that it may be sold or converted into an appropriate article.

In recent years, there have been a number of developments in the determination of some very basic compositional properties of bales of material for recycling (i.e. polyolefin waste that is to enter a mechanical polyolefin recycling process), for example EP 3 465 151 A1.

What is not, however, known, is a far more thorough characterisation of the recycling stream during the mechanical polyolefin recycling process. Such a system would allow for a far greater understanding of the interplay between individual constituent steps and enable optimisation of the overall recycling process with reduced trial and error. Furthermore, such a system would also enable quality control of a mechanical polyolefin recycling process, whereby any faults in the recycled polyolefin can be immediately traced back to a poorly performing constituent step, which can be suitably adjusted to eradicate the fault.

### SUMMARY OF THE INVENTION

As such, the present invention is directed to a process for collecting and storing quality control data of a polyolefin recycling stream at one or more intermediate positions of a mechanical polyolefin recycling process, wherein the quality control data is any measurable mechanical, rheological or compositional property or properties of the polyolefin(s) present in the polyolefin recycling stream that is collected via a method selected from the group consisting of headspace-gas chromatography-mass spectrometry (HS-GC-MS), high pressure liquid chromatography (HPLC), temperature modulated differential scanning calorimetry (TM-DSC), thermogravimetric analysis of ash content (TGA), dynamic rheology measurement via frequency sweep analysis, large amplitude oscillatory shear (LAOS) measurements, uniaxial extensional flow measurements (SER), X-ray fluorescence measurements (XRF), laser spectroscopy such as Raman spectroscopy, CIELAB spectrophotometric measurements, and combinations thereof.

In another embodiment, the present invention is directed to a process for optimising the performance of a mechanical polyolefin recycling process, wherein the process comprises a step of adjusting the process conditions of one or more constituent steps within the mechanical polyolefin recycling process in response to quality control data measured on a polyolefin recycling stream at one or more intermediate positions of the mechanical polyolefin recycling process, wherein the quality control data is any measurable mechanical, rheological or compositional property or properties of the polyolefin(s) present in the polyolefin recycling stream, and wherein optimising the performance of the mechanical polyolefin recycling process involves the improvement of one or more mechanical, rheological and/or compositional properties of the recycled polyolefin composition.

It is particularly preferred that the mechanical polyolefin recycling process of the processes of the present invention comprises, in the given order, the steps of:
a) providing a precursor mixed plastic recycling stream (A);
b) sieving the precursor mixed plastic recycling stream (A) to create a sieved mixed plastic recycling stream (B) having only articles with a longest dimension in the range from 30 to 400 mm;
c) sorting the sieved mixed plastic recycling stream (B) by means of one or more optical sorters wherein the sieved mixed plastic recycling stream (B) is a least sorted by colour and optionally also by polyolefin type and/or article form, thereby generating a single-colour sorted polyolefin recycling stream (C);
d) reducing the size of the pieces of the single-colour sorted polyolefin recycling stream (C) to form a flaked polyolefin recycling stream (D);
e) washing the flaked polyolefin recycling stream (D) with a first aqueous washing solution (W1) without the input of thermal energy, thereby generating a first suspended polyolefin recycling stream (E);
f) removing the first aqueous washing solution (W1) from the first suspended polyolefin recycling stream (E) to obtain a first washed polyolefin recycling stream (F);
g) washing the first washed polyolefin recycling stream (F) with a second aqueous washing solution (W2) thereby generating a second suspended polyolefin recycling stream (G), wherein sufficient thermal energy is input to the system to raise the temperature to a temperature in the range from 65 to 95° C. during the washing;
h) removing the second aqueous washing solution (W2) and any material not floating on the surface of the second aqueous washing solution from the second suspended polyolefin recycling stream (G) to obtain a second washed polyolefin recycling stream (H);
i) drying the second washed polyolefin recycling stream (H), thereby obtaining a dried polyolefin recycling stream (I);
j) optionally separating the dried polyolefin recycling stream (I) into a light fraction and a heavy fraction polyolefin recycling stream (J);
k) further sorting the heavy fraction polyolefin recycling stream (J) or, in the case that step j) is absent, the dried polyolefin recycling stream (I) by means of one or more optical sorters to remove any flakes containing material other than the target polyolefin, yielding a purified polyolefin recycling stream (K);
l) optionally melt extruding, preferably pelletizing, the purified polyolefin recycling stream (K), preferably wherein additives (Ad) are added in the melt state, to form an extruded, preferably pelletized, recycled polyolefin product (L); and
m) optionally aerating the recycled polyolefin product (L) or, in the case that step l) is absent, the purified polyolefin recycling stream (K) to remove volatile organic compounds, thereby generating an aerated recycled polyolefin product (M), being either an aerated extruded, preferably pelletized, recycled polyolefin product (M1) or aerated recycled polyolefin flakes (M2),
wherein the order of steps l) and m) can be interchanged, such that the purified polyolefin recycling stream (K) is first aerated to form aerated recycled polyolefin flakes (M2) that are subsequently extruded, preferably wherein additives (Ad) are added in the melt state, to form an extruded, preferably pelletized, aerated recycled polyolefin product (M3), and
wherein the one or more intermediate positions of the recycling stream are selected from the group consisting of between steps b) and c), between steps c) and d), between steps d) and e), between steps e) and f), between steps f) and g), between steps g) and h), between steps h) and i), between steps i) and j) and between steps j) and k) if j) is present or between steps i) and k) if j) is not present, and, when the relevant steps are present, between steps k) and l), steps k) and m), steps l) and m) and steps m) and l).

In an another embodiment, the present invention is directed to a computer-implemented method for providing training data for an adjustment control model configured to adjust the process conditions of one or more constituent steps of a mechanical polyolefin recycling process at least based on the measured quality control data in a process according to any one of the preceding claim, comprising the steps:
providing quality control data of the process according to any one of the preceding claims;
providing adjustment data corresponding to an adjustment of the process conditions in view of the provided quality control data;
labelling the quality control data with the adjustment data.

In a further embodiment, the present invention is directed to an adjustment control model at least trained with training data provided according to the computer-implemented method of the present invention.

The present invention is also directed to a use of a measurement method for obtaining quality control data at an intermediate point of a mechanical polyolefin recycling process, wherein the measurement method is selected from the group consisting of headspace-gas chromatography-mass spectrometry (HS-GC-MS), high pressure liquid chromatography (HPLC), temperature modulated differential scanning calorimetry (TM-DSC), thermogravimetric analysis of ash content (TGA), dynamic rheology measurement via frequency sweep analysis, large amplitude oscillatory shear (LAOS) measurements, uniaxial extensional flow measurements (SER), X-ray fluorescence measurements (XRF), laser spectroscopy such as Raman spectroscopy, CIELAB spectrophotometric measurements, and combinations thereof, wherein the quality control data is any measurable mechanical, rheological or compositional property or properties of the polyolefin(s) present in the polyolefin recycling stream that is measurable using the measurement method.

In a final embodiment, the present invention is directed to a use of quality control data obtained at an intermediate position of a mechanical polyolefin recycling process to adjust the process conditions of one or more constituent steps within the mechanical polyolefin recycling process for optimising the performance of the mechanical polyolefin recycling process, wherein the quality control data is any measurable mechanical, rheological or compositional property or properties of the polyolefin(s) present in a polyolefin recycling stream in the mechanical polyolefin recycling process, and wherein optimising the performance of the mechanical polyolefin recycling process involves the improvement or one or more mechanical, rheological and/or compositional properties of the recycled polyolefin composition.

### Definitions

In the context of the present invention, a polyolefin recycling stream may be any stream suitable for recycling, wherein polyolefin is present. This polyolefin may originate from post-consumer or post-industrial waste. Post-consumer waste refers to objects having completed at least a first use cycle (or life cycle), i.e. having already served their first purpose; while industrial waste refers to manufacturing scrap, which does not normally reach a consumer.

Recycling streams may contain both articles for recycling and fragments of articles for recycling, herein termed flakes. In the context of the present invention, the content of the recycling streams will be referred to as pieces, irrespective of whether these pieces are whole articles, fragments thereof, or flakes thereof. In certain embodiments, the pieces may be flakes, whereas in other embodiments pieces may be larger objects that may be converted into flakes at a later stage. In the context of the present invention, the terms “flake”, “flakes” and “flaked form” are used to indicate that the polyolefin-containing piece is not a full article, but has been broken down. This includes flakes of films (so-called 2D flakes) and flakes of rigid articles (so-called 3D flakes). As such, in the context of the present invention, these terms should be interpreted simply as excluding the presence of entire articles in the recycling stream. Preferably, flakes have a longest dimension in the range from 2 to 25 mm.

In the context of the present invention, a mixed plastic recycling stream may be any stream suitable for recycling, wherein polyolefin is present and the stream does not only contain a single polyolefin product, as would be the case, for example, for certain post-industrial waste recycling streams wherein the production waste of a single polyolefin grade, or a single polyolefin-containing article may be the only piece present in the stream. Generally speaking, all polyolefin-containing post-consumer waste recycling streams will be mixed plastic recycling streams, as will many polyolefin-containing post-industrial waste recycling streams.

The term “article form”, as used herein, refers to the shape and form of articles present in a polyolefin recycling stream. Such articles may be present, inter alia, in the form of films, bags, and pouches, which may be considered as flexible articles, and, inter alia, in the form of moulded articles such as food containers, skin-care product containers, and plastic bottles, which may be considered as rigid articles. Commercial optical sorters, such as Tomra Autosort, RTT Steinert Unisort, and Redwave Pellenc, are able to separate so-called rigid articles from so-called flexible articles via their aerodynamic properties (i.e. a stream of gas is typically applied to the stream and those articles being rigid articles will fall with a different arc than flexible articles), converting streams containing such articles into so-called rigid streams and flex streams.

According to aspects of the present invention, a single-colour sorted polyolefin stream (C) is obtained as an intermediate product, as a result of a sorting process wherein the polyolefin-containing articles are at least sorted by their colour. The person skilled in the art would be aware that a considerable amount of polyolefin-containing articles in any given mixed-colour recycling stream would be transparent, i.e. colourless. For the purposes of the present invention, any transparent, i.e. colourless, polyolefin-containing articles are considered to be a separate colour classification, resulting in a single-colour sorted polyolefin stream (C) wherein the ‘colour’ is colourless (i.e. transparent). In some embodiments, this colourless polyolefin recycling stream undergoes the subsequent steps of the method resulting in a colourless recycled product or, in other embodiments, the colourless polyolefin recycling stream is mixed with a non-colourless single colour recycling stream (e.g. a white polyolefin recycling stream) with the mixed stream considered to be a single-colour recycling stream of the non-colourless colour (i.e. a mixture of a colourless stream with a white stream would thereafter be considered as a white stream). Whilst not wishing to be bound by theory, it is believed that the addition of colourless polyolefin to non-colourless polyolefin recycling streams does not notably influence the final colour of the recycled product.

According to aspects of the present invention, it is essential that a single-colour sorted recycling stream is exposed to the later processing steps d) through m). In the context of the present invention, the term “single colour” is to be interpreted as meaning substantially the same colour, i.e. a polyolefin stream containing pieces of various shades of red would be classed as a single-colour stream, whereas a polyolefin stream containing yellow pieces as well as red pieces would not be classed as a single-colour stream. The precision with which a single colour may be selected is dependent on the techniques used to sort by colour, and is thus limited by the available technology. Since the impression of colour on the human eye cannot be strictly defined by wavelength, given that the same colour may be achieved with a single wavelength of light and a combination of different wavelengths, definition on the CIELAB colour scale is the most suitable descriptor. It is particularly preferred that same-colour means that ΔE<50, preferably ΔE<40, more preferably ΔE<30 and most preferably. ΔE is defined by the formula below:

$$Δ {E}_{ab}^{*} = \sqrt{{( {L}_{2}^{*} - {L}_{1}^{*} )}^{2} + {( {a}_{2}^{*} - {a}_{1}^{*} )}^{2} + {( {b}_{2}^{*} - {b}_{1}^{*} )}^{2}}$$

in which
(L*₂−L*₁) represents difference in lightness between the sample and a predefined colour,
(a*₂−a*₁) represents the difference in redness or greyness between the sample and the predefined colour, and
(b*₂−b*₁) represents blueness-yellowness differences between the sample and the predefined colour.

Furthermore, the skilled person would be aware that state of the art sorting processes, such as those involving automated sorters of the type discussed below, do not result in perfect sorting, meaning that any wording such as “wherein the stream contains only a single colour” or “wherein the stream contains only a single polyolefin type” are to be interpreted broadly, wherein the streams thus described contain substantially only the stated colour or polyolefin type, but are not 100% pure due to technical limitations of the sorting steps.

The person skilled in the art would be aware that pH values of greater than 14.0 and lower than 0.0 are theoretically possible; however, they would also be aware that the determination of such pH values is incredibly difficult using conventional pH probes. As such, in the context of this invention, aqueous solutions having an effective pH of greater than 14.0 are considered to have a pH of 14.0 and aqueous solutions having an effective pH of lower than 0.0 are considered to have a pH of 0.0.

In the context of the present invention, the term “rinse” is used to indicate the addition of a solvent, typically water, which is used to remove foreign material or remaining liquid from the surface of the polyolefin. This can be achieved in very short times, i.e. less than 5 minutes, often less than 1 minute, in contrast to “washing” steps that typically require a longer time, and agitation, to remove adherent foreign material from the surface of the polyolefin and potentially extract volatile organic compounds from the polyolefin.

As would be clear to the person skilled in the art, in so far as the present invention is directed to a process for collecting and storing quality control data, this wording does not include processes wherein data is measured, transiently analyzed, for example in a sorting process, and immediately discarded. Such processes, wherein a polymer stream is sorted with the aid of one or more detection methods, such as IR spectroscopy, X-ray fluorescence measurements (XRF), and laser spectroscopy such as Raman spectroscopy are used to classify each piece of polyolefin, and said classification is used to determine whether the piece is sorted into one stream or into a different stream, are well known in the art. These processes are distinguished from those of the present invention by the feature “storing quality control data”, which allows for complex analysis and optimisation of the mechanical polyolefin recycling process on the basis of said stored quality control data.

Where the term “comprising” is used in the present description and claims, it does not exclude other non-specified elements of major or minor functional importance. For the purposes of the present invention, the term “consisting of” is considered to be a preferred embodiment of the term “comprising of”. If hereinafter a group is defined to comprise at least a certain number of elements, this is also to be understood to disclose a group, which preferably consists only of these elements.

Where an indefinite or definite article is used when referring to a singular noun, e.g. “a”, “an” or “the”, this includes a plural of that noun unless something else is specifically stated.

### DETAILED DESCRIPTION OF THE INVENTION

In a first aspect, the present invention is directed to a process for collecting and storing quality control data of a polyolefin recycling stream at one or more intermediate positions of a mechanical polyolefin recycling process, wherein the quality control data is any measurable mechanical, rheological or compositional property or properties of the polyolefin(s) present in the polyolefin recycling stream that is collected via a method selected from the group consisting of headspace-gas chromatography-mass spectrometry (HS-GC-MS), high pressure liquid chromatography (HPLC), temperature modulated differential scanning calorimetry (TM-DSC), thermogravimetric analysis of ash content (TGA), dynamic rheology measurement via frequency sweep analysis, large amplitude oscillatory shear (LAOS) measurements, uniaxial extensional flow measurements (SER), X-ray fluorescence measurements (XRF), laser spectroscopy such as Raman spectroscopy, CIELAB spectrophotometric measurements, and combinations thereof.

In the context of the present invention, a mechanical polyolefin recycling process is any process that takes post-consumer or post-industrial waste and produces a recycled polyolefin composition. Typically, such a process involves a combination of many individual steps, such as washing, sorting, aerating, shredding etc. In contrast to a chemical recycling process, a mechanical polyolefin recycling process does not involve the chemical degradation of the polyolefin, but is a simple mechanical reprocessing of polyolefins having reached the end of their intended use. That said, the skilled person would be aware that, as with any polymer-processing step, polymer chains may be broken during a mechanical recycling process, leading to a minor degradation of the polymer. The skilled person would understand that this minor degradation is not equivalent to the chemical degradation required for a chemical recycling process.

In the broadest sense, the present invention is not dependent on the precise nature of the mechanical polyolefin recycling process, but rather the presence of at multiple constituent steps, as is typical for such mechanical polyolefin recycling processes.

Formally speaking, the first step in any mechanical process would be the provision of a polyolefin recycling stream. This is typically provided in bale form and may be gathered and collected or alternatively a waste polyolefin bale may be purchased from various commercial enterprises.

Following this step, there are typically a number of processing steps, which may include, but are not restricted to, size reduction, sorting, washing and aerating.

After these processing steps, the processed polyolefin may be provided in any form; however, it is typical that the processed polyolefin is in flaked form. This flaked form may either be packaged and sold as flaked recycled polyolefin, or compounded to form recycled polyolefin pellets and/or recycled polyolefin articles.

It is common practice in the art to measure the mechanical, rheological and compositional properties of the recycled polyolefin at the end of the mechanical polyolefin recycling process. This provides simple quality control data that can be used to evaluate the mechanical polyolefin recycling process. This characterisation data is typically required to sell the recycled polyolefin.

What is not, however, typically undertaken is a measurement (or measurements) of a property (or properties) at an intermediate position of the process.

In the context of the present invention, an intermediate position is any position of the mechanical polyolefin recycling process other than the beginning (i.e. after the provision of the waste polyolefin (i.e. polyolefin recycling stream) prior to the first processing step) or the end (i.e. the stage at which the recycled polyolefin (either in the form of flakes, pellets or articles) is obtained, ready for sale).

Measurement at an intermediate position may be between two of the constituent steps of the mechanical polyolefin recycling process or alternatively it may be during one of the constituent step of the mechanical polyolefin recycling process, through either an online determination of the relevant property or by removing a sample from within a particular constituent step for offline testing. Depending on the nature of the constituent steps, the gathering of suitable quality control data during the constituent step may be considerably more difficult, thus it is preferred that the quality control data is obtained at an intermediate position that is between two of the constituent steps.

If the quality control data is obtained at an intermediation position that is during one of the constituent steps, then it is preferred that this step is not a sorting step. Accordingly, it is preferred that at least one of the one or more intermediate positions of the mechanical polyolefin recycling process is at an intermediate position other than during a sorting step, more preferably all of the one or more intermediate positions of the mechanical polyolefin recycling process are at intermediate positions other than during a sorting step.

According to the present invention, the quality control data must be collected at one or more intermediate positions, more preferably two or more intermediate positions, more preferably three or more intermediate positions, yet more preferably four or more intermediate positions, most preferably κ or more intermediate positions of the mechanical polyolefin recycling process.

In the broadest sense, the quality control data collected may be any mechanical, rheological or compositional property.

According to the first aspect of the present invention, the quality control data must be collected via a method selected from the group consisting of headspace-gas chromatography-mass spectrometry (HS-GC-MS), high pressure liquid chromatography (HPLC), temperature modulated differential scanning calorimetry (TM-DSC), thermogravimetric analysis of ash content (TGA), dynamic rheology measurement via frequency sweep analysis, large amplitude oscillatory shear (LAOS) measurements, uniaxial extensional flow measurements (SER), X-ray fluorescence measurements (XRF), laser spectroscopy such as Raman spectroscopy, CIELAB spectrophotometric measurements, and combinations thereof.

In addition to the methods given above, further quality control data may be collected by melt flow rate measurement (MFR) and/or Fourier-transform infrared spectroscopy (FT-IR).

Whilst each of the measurement methods listed above would provide direct evidence of a particular property of the polyolefin present in the polyolefin recycling stream (e.g. ash content, content of volatiles and semi volatiles (VOC and FOG)), many methods can provide a deeper understanding of the makeup of the polyolefin recycling stream beyond the simple checking of a particular property.

In the context of the present invention, however, although the measured data can be used to infer other properties of the polyolefin recycling stream, the quality control data refers simply to the directly measured properties obtainable via the measurement methods listed above.

In a second aspect, the present invention is directed to a process for optimising the performance of a mechanical polyolefin recycling process, wherein the process comprises a step of adjusting the process conditions of one or more constituent steps within the mechanical polyolefin recycling process in response to quality control data measured on a polyolefin recycling stream at one or more intermediate positions of the mechanical polyolefin recycling process, wherein the quality control data is any measurable mechanical, rheological or compositional property or properties of the polyolefin(s) present in the polyolefin recycling stream, and wherein optimising the performance of the mechanical polyolefin recycling process involves the improvement of one or more mechanical, rheological and/or compositional properties of the recycled polyolefin composition.

The key step of the process of the second aspect is the step of adjusting the process conditions of one or more constituent steps within the mechanical polyolefin recycling process in response to quality control data measured on a polyolefin recycling stream at one or more intermediate positions of the mechanical polyolefin recycling process.

This quality control data is any measurable mechanical, rheological or compositional property or properties of the polyolefin(s) present in the polyolefin recycling stream.

In the second aspect, it is preferred that quality control data be collected via a method selected from the group consisting of headspace-gas chromatography-mass spectrometry (HS-GC-MS), high pressure liquid chromatography (HPLC), temperature modulated differential scanning calorimetry (TM-DSC), thermogravimetric analysis of ash content (TGA), dynamic rheology measurement via frequency sweep analysis, large amplitude oscillatory shear (LAOS) measurements, uniaxial extensional flow measurements (SER), X-ray fluorescence measurements (XRF), laser spectroscopy such as Raman spectroscopy, CIELAB spectrophotometric measurements, and combinations thereof.

In addition to the methods given above, further quality control data may be collected by melt flow rate measurement and/or Fourier-transform infrared spectroscopy (FT-IR).

Each constituent step that is adjusted in the second aspect (i.e. one or more constituent steps) can either be upstream or downstream from the intermediate position at which the measurement of the quality control data has been made. If more than one intermediate position has been used, then the constituent step can be upstream of all intermediate positions, downstream of all intermediate positions or upstream of some intermediate positions and downstream of other intermediate positions.

The terms upstream and downstream refer to the position of the constituent step with reference to the direction of flow of the polyolefin recycling stream through the mechanical recycling process.

In one embodiment of the second aspect, at least one of the one or more constituent steps of the step of adjusting the process conditions of one or more constituent steps within the mechanical polyolefin recycling process is a constituent step upstream from the intermediate position from which the quality control data has been measured.

In this embodiment, perturbations in the desired properties of the recycled polyolefin at the intermediate position are determined providing a method of evaluating the preceding constituent steps. These steps can be adjusted to fine-tune the properties of the polyolefin recycling stream at the intermediate position in the future.

In another embodiment of the second aspect, at least one of the one or more constituent steps of the step of adjusting the process conditions of one or more constituent steps within the mechanical polyolefin recycling process is a constituent step downstream from the intermediate position from which the quality control data has been measured.

In this embodiment, it is theoretically possible to adjust the properties of the polyolefin recycling stream in order to avoid the detected perturbation from being present at the end of the recycling process. In other words, an observed flaw in the mechanical polyolefin recycling process in one of the upstream constituent steps can be compensated for by adjusting the process conditions of one of the downstream constituent steps, thus avoiding sub-par recycled polyolefin product at the end of the process.

Each of these embodiments (upstream adjustment and downstream adjustment) can be used independently or alternatively both may be used together.

A number of further embodiments are applicable to both the first and second aspect as described above.

In one embodiment, the process is a computer-implemented method.

In another embodiment, the measurement of the quality control data is conducted on-line, meaning that the polyolefin whose properties are being measured is not removed from the recycling process.

In a further embodiment, the measurement of the quality control data is conducted off-line, meaning that the polyolefin whose properties are being measured is removed from the recycling process.

Whether the measurement of the quality control data is conducted on- or off-line depends primarily on the nature of the measurement method being carried out. Some measurements, such as IR spectroscopy, can easily be carried out remotely without destroying the sample, whereas others, such as thermogravimetric analysis (TGA), headspace-gas chromatography-mass spectrometry (HS-GC-MS), high pressure liquid chromatography (HPLC), and temperature modulated differential scanning calorimetry (TM-DSC), for example, would need to be carried out on samples removed from the process.

It is further preferred that the polyolefin being measured in the recycling stream is in flaked form.

Most constituent steps of the mechanical polyolefin recycling process are improved by having the polyolefin in flaked form; therefore, the polyolefin is typically in such a form during and after such steps.

For some measurement methods, the polyolefin would need to be further processed from the flaked form as present in the recycling stream, for example cryo-milled. The requirement that the polyolefin being measured in the recycling stream be in flaked form does not exclude such further steps, but rather simply requires that the polyolefin is in flaked form in the recycling stream. For online measurements, this would mean that the quality control data is measured on a flake: however, this need not be the case for offline measurements.

Whilst the mechanical polyolefin recycling process can be any collection of constituent steps known in the art, it is particularly preferred that the mechanical polyolefin recycling process comprises, in the given order, the steps of:
a) providing a precursor mixed plastic recycling stream (A);
b) sieving the precursor mixed plastic recycling stream (A) to create a sieved mixed plastic recycling stream (B) having only articles with a longest dimension in the range from 30 to 400 mm;
c) sorting the sieved mixed plastic recycling stream (B) by means of one or more optical sorters wherein the sieved mixed plastic recycling stream (B) is a least sorted by colour and optionally also by polyolefin type and/or article form, thereby generating a single-colour sorted polyolefin recycling stream (C);
d) reducing the size of the pieces of the single-colour sorted polyolefin recycling stream (C) to form a flaked polyolefin recycling stream (D);
e) washing the flaked polyolefin recycling stream (D) with a first aqueous washing solution (W1) without the input of thermal energy, thereby generating a first suspended polyolefin recycling stream (E);
f) removing the first aqueous washing solution (W1) from the first suspended polyolefin recycling stream (E) to obtain a first washed polyolefin recycling stream (F);
g) washing the first washed polyolefin recycling stream (F) with a second aqueous washing solution (W2) thereby generating a second suspended polyolefin recycling stream (G), wherein sufficient thermal energy is input to the system to raise the temperature to a temperature in the range from 65 to 95° C. during the washing;
h) removing the second aqueous washing solution (W2) and any material not floating on the surface of the second aqueous washing solution from the second suspended polyolefin recycling stream (G) to obtain a second washed polyolefin recycling stream (H);
i) drying the second washed polyolefin recycling stream (H), thereby obtaining a dried polyolefin recycling stream (I);
j) optionally separating the dried polyolefin recycling stream (I) into a light fraction and a heavy fraction polyolefin recycling stream (J);
k) further sorting the heavy fraction polyolefin recycling stream (J) or, in the case that step j) is absent, the dried polyolefin recycling stream (I) by means of one or more optical sorters to remove any flakes containing material other than the target polyolefin, yielding a purified polyolefin recycling stream (K);
l) optionally melt extruding, preferably pelletizing, the purified polyolefin recycling stream (K), preferably wherein additives (Ad) are added in the melt state, to form an extruded, preferably pelletized, recycled polyolefin product (L); and
m) optionally aerating the recycled polyolefin product (L) or, in the case that step l) is absent, the purified polyolefin recycling stream (K) to remove volatile organic compounds, thereby generating an aerated recycled polyolefin product (M), being either an aerated extruded, preferably pelletized, recycled polyolefin product (M1) or aerated recycled polyolefin flakes (M2),
wherein the order of steps l) and m) can be interchanged, such that the purified polyolefin recycling stream (K) is first aerated to form aerated recycled polyolefin flakes (M2) that are subsequently extruded, preferably wherein additives (Ad) are added in the melt state, to form an extruded, preferably pelletized, aerated recycled polyolefin product (M3), and
wherein the one or more intermediate positions of the recycling stream are selected from the group consisting of between steps b) and c), between steps c) and d), between steps d) and e), between steps e) and f), between steps f) and g), between steps g) and h), between steps h) and i), between steps i) and j) and between steps j) and k) if j) is present or between steps i) and k) if j) is not present, and, when the relevant steps are present, between steps k) and l), steps k) and m), steps l) and m) and steps m) and l).

Particularly preferred intermediate positions in the above mechanical polyolefin recycling process include between steps c) and d), between steps d) and e), between steps f) and g), between steps i) and j) and between steps j) and k) if j) is present or between steps i) and k) if j) is not present, and, when the relevant steps are present, between steps k) and l), steps k) and m), steps l) and m) and steps m) and l).

The above mechanical polyolefin recycling process is described in detail in European patent application EP 21 216 996.5. All fallback positions and preferable embodiments disclosed with regard the mechanical polyolefin recycling process therein are applicable mutatis mutandis to the mechanical polyolefin recycling process of the above embodiment.

Step a) involves the provision of a precursor mixed plastic recycling stream (A).

This precursor mixed plastic recycling stream (A) may originate from post-consumer waste, post-industrial waste or a combination thereof.

Step b) involves sieving the precursor mixed plastic recycling stream (A) to create a sieved mixed plastic recycling stream (B) having only articles with a longest dimension in the range from 30 to 400 mm.

The person skilled in the art would be aware of multiple ways in which the sieving of step b) could be achieved and, as such, this sieving step is not particularly limited. That said, it is preferred that the sieving of step b) is achieved by using one sieve with a sieve diameter of 30 mm and another sieve with a sieve diameter of 400 mm to divide the precursor mixed recycling stream into three streams, an undersized stream of articles having a longest dimension of less than 30 mm, an oversized stream of articles having a longest dimension of greater than 400 mm and the sieved mixed plastic recycling stream (B). The undersized and oversized streams may either be discarded or redirected for use in other mechanical polyolefin recycling processes.

Step c) involves sorting the sieved mixed plastic recycling stream (B) by means of one or more optical sorters wherein the sieved mixed plastic recycling stream (B) is a least sorted by colour and optionally also by polyolefin type and/or article form, thereby generating a single-colour sorted polyolefin recycling stream (C).

Any articles that are separated from the single-colour sorted polyolefin recycling stream (C) can either be discarded or redirected back into further iterations of step c) that target a different single-colour sorted polyolefin recycling stream.

It is preferred that the sorting of step c) sorts according to colour, polyolefin type and article form, meaning that the single-colour sorted polyolefin recycling stream (C) is a single colour, all articles contain a single polyolefin and that the stream contains only rigid or flexible articles.

Although the processes of the present invention are suitable for the isolation of any desired polyolefin from a polyolefin mixed recycling stream, the isolation of polyethylene or polypropylene is particularly desirable, since these will most likely be the major polyolefin components of any polyolefin mixed recycling stream, and isolated polyethylene or isolated polypropylene can be fed into pure recycled polyolefin streams or extruded and pelletized along to afford pellets of the desired polyolefin, i.e. of polyethylene or polypropylene.

It is particularly preferred that the single-colour sorted polyolefin recycling stream (C) is either a single-colour sorted polyethylene recycling stream or a single-colour sorted polypropylene recycling stream.

Step d) involves reducing the size of the pieces of the single-colour sorted polyolefin recycling stream (C) to form a flaked polyolefin recycling stream (D).

The size-reduction of step d) may be carried out by any method known to the person skilled in the art, for example milling or shredding the single-colour sorted polyolefin recycling stream (C).

Step e) involves washing the flaked polyolefin recycling stream (D) with a first aqueous washing solution (W1) without the input of thermal energy, thereby generating a first suspended polyolefin recycling stream (E).

The person skilled in the art would be aware that known washing steps in the art may be either heated to achieve a high temperature wash or alternatively can be conducted at ambient conditions to achieve a low temperature wash. In the present process, step e) corresponds to such a low temperature wash.

Step f) involves removing the first aqueous washing solution (W1) from the first suspended polyolefin recycling stream (E) to obtain a first washed polyolefin recycling stream (F).

The person skilled in the art would understand that small amounts of foreign material that is either suspended or dissolved in the first suspended polyolefin recycling stream (E) would be removed with the first aqueous washing solution (W1); however, step f) does not involve the targeted removal of foreign material through the use of, for example, a so-called float/sink separation, wherein all foreign material that does not float on the surface of the solution (given that it would be expected that polyolefins having a density of less than 1.00 g/cm³ would float) are removed with the solution.

Step g) involves washing the first washed polyolefin recycling stream (F) with a second aqueous washing solution (W2) thereby generating a second suspended polyolefin recycling stream (G), wherein sufficient thermal energy is input to the system to raise the temperature to a temperature in the range from 65 to 95° C. during the washing.

As discussed above, the person skilled in the art would be aware that known washing steps in the art may be either heated to achieve a high temperature wash or alternatively can be conducted at ambient conditions to achieve a low temperature wash. The washing of step g), in contrast to that of step e) is a high temperature wash, wherein thermal energy is input to ensure a temperature of 65 to 95° C. during the washing.

The temperature of step g) is in the range from 65 to 95° C., more preferably in the range from 70 to 95° C., most preferably in the range from 75 to 95° C.

It is preferred that the second aqueous washing solution (W2) is an alkaline aqueous washing solution.

In one particularly preferred embodiment, the second aqueous washing solution (W2) is a sodium hydroxide solution having a sodium hydroxide concentration in the range from 0.50 to 5.0 wt.-%, relative to the total weight of the second aqueous washing solution (W2).

Step h) involves removing the second aqueous washing solution (W2) and any material not floating on the surface of the first aqueous washing solution from the second suspended polyolefin recycling stream (G) to obtain a second washed polyolefin recycling stream (H).

In contrast to step f), wherein only minor amounts of foreign material suspended or dissolved in the washing solution are removed, step h) involves a so-called float/sink separation, whereby any and all material not floating on the surface of the washing solution is removed. This would be understood by the person skilled in the art to have the effect of removing any foreign material having a density of greater than 1.00 g/cm³.

Step i) involves drying the second washed polyolefin recycling stream (H), thereby obtaining a dried polyolefin recycling stream (I).

The drying of step i) can be achieved through thermal drying or through a combination of mechanical and thermal drying. Suitable forms of mechanical drying include centrifugal drying and a dewatering press (filter or screw-press), each of which allows for the separation of liquids from solids.

Step j), if present, involves separating the dried polyolefin recycling stream (I) into a light fraction and a heavy fraction polyolefin recycling stream (J).

The light fraction typically contains labels and other non-polyolefin materials, whereas the polyolefin flakes are sorted into the heavy fraction polyolefin recycling stream (J).

The separation of step j) can be carried out by any known dry-state density separation technique known in the art. Suitable techniques include pneumatic classifying, wind sifters and zig zag cascade or air separators.

Step k) involves further sorting the heavy fraction polyolefin recycling stream (J) or, in the case that step j) is absent, the dried polyolefin recycling stream (I) by means of one or more optical sorters to remove any flakes containing material other than the target polyolefin, yielding a purified polyolefin recycling stream (K).

Step k) uses at least a first optical sorter to remove any flake that contains material other than the target polyolefin. The selection criteria in this optical sorter are that if any material other than the target polyolefin is present in a given flake, that this flake will be separate from the stream, affording a purified polyolefin recycling stream. Multiple optical sorters having the same sorting criteria may be arranged in series to improve the purity of the purified polyolefin recycling stream (K).

Step l), if present, involves melt extruding, preferably pelletizing, the purified polyolefin recycling stream (K), preferably wherein additives (Ad) are added in the melt state, to form an extruded, preferably pelletized, recycled polyolefin product (L).

Step m), if present, involves aerating the recycled polyolefin product (L) or, in the case that step l) is absent, the purified polyolefin recycling stream (K) to remove volatile organic compounds, thereby generating an aerated recycled polyolefin product (M), being either an aerated extruded, preferably pelletized, recycled polyolefin product (M1) or aerated recycled polyolefin flakes (M2).

The aeration of step m) may be achieved, inter alia, through the use of air, inert gases or steam.

It is further preferred that the process further comprises the step of providing an adjustment control model configured to adjust the process conditions of the one or more constituent steps at least based on the measured quality control data.

Such a control model is preferably based on the results of a machine-learning algorithm, wherein the term machine-learning algorithm has to be understood broadly and preferably comprises decision trees, naive bayes classifications, nearest neighbours, neural networks, convolutional neural networks, generative adversarial networks, support vector machines, linear regression, logistic regression, random forest and/or gradient boosting algorithms. Preferably, the machine-learning algorithm is organized to process an input having a high dimensionality into an output of a much lower dimensionality. Such a machine-learning algorithm is termed “intelligent” because it is capable of being “trained”. The algorithm may be trained using records of training data. A record of training data comprises training input data and corresponding training output data. The training output data of a record of training data is the result that is expected to be produced by the machine-learning algorithm when being given the training input data of the same record of training data as input. The deviation between this expected result and the actual result produced by the algorithm is observed and rated by means of a “loss function”. This loss function is used as a feedback for adjusting the parameters of the internal processing chain of the machine-learning algorithm. For example, the parameters may be adjusted with the optimization goal of minimizing the values of the loss function that result when all training input data is fed into the machine-learning algorithm and the outcome is compared with the corresponding training output data. The result of this training is that given a relatively small number of records of training data as “ground truth”, the machine-learning algorithm is enabled to perform its job well for a number of records of input data that higher by many orders of magnitude.

Notably, the above-described methods/processes may be carried out by means of a computer program element. The computer program element might be stored on a computing unit of a computing device, which might also be part of an embodiment. This computing unit may be configured to perform or induce performing of the steps of the method described above.

Moreover, it may be configured to operate the components of the above-described system. The computing unit can be configured to operate automatically and/or to execute the orders of a user. The computing unit may include a data processor. A computer program may be loaded into a working memory of a data processor. The data processor may thus be equipped to carry out the method according to one of the preceding embodiments. This exemplary embodiment of the present disclosure covers both, a computer program that right from the beginning uses the present disclosure and computer program that by means of an update turns an existing program into a program that uses the present disclosure. Moreover, the computer program element might be able to provide all necessary steps to fulfil the procedure of an exemplary embodiment of the method as described above. According to a further exemplary embodiment of the present disclosure, a computer readable medium, such as a CD-ROM, USB drive, a downloadable executable or the like, is presented wherein the computer readable medium has a computer program element stored on it which computer program element is described by the preceding section. A computer program may be stored and/or distributed on a suitable medium, such as an optical storage medium or a solid-state medium supplied together with or as part of other hardware, but may also be distributed in other forms, such as via the internet or other wired or wireless telecommunication systems. However, the computer program may also be presented over a network like the World Wide Web and can be downloaded into the working memory of a data processor from such a network. According to a further exemplary embodiment of the present disclosure, a medium for making a computer program element available for downloading is provided, which computer program element is arranged to perform a method according to one of the previously described embodiments of the present disclosure.

In another embodiment, the present invention is directed to a computer-implemented method for providing training data for an adjustment control model configured to adjust the process conditions of one or more constituent steps of a mechanical polyolefin recycling process at least based on the measured quality control data in a process according to any one of the preceding claim, comprising the steps:
providing quality control data of the process according to any one of the preceding claims;
providing adjustment data corresponding to an adjustment of the process conditions in view of the provided quality control data;
labelling the quality control data with the adjustment data.

The present invention is further directed to an adjustment control model at least trained with training data provided by the computer-implemented method as described above.

In another aspect, the present invention is directed to a use of a measurement method for obtaining quality control data at an intermediate point of a mechanical polyolefin recycling process, wherein the measurement method is selected from the group consisting of headspace-gas chromatography-mass spectrometry (HS-GC-MS), high pressure liquid chromatography (HPLC), temperature modulated differential scanning calorimetry (TM-DSC), thermogravimetric analysis of ash content (TGA), dynamic rheology measurement via frequency sweep analysis, large amplitude oscillatory shear (LAOS) measurements, uniaxial extensional flow measurements (SER), X-ray fluorescence measurements (XRF), laser spectroscopy such as Raman spectroscopy, CIELAB spectrophotometric measurements, and combinations thereof, wherein the quality control data is any measurable mechanical, rheological or compositional property or properties of the polyolefin(s) present in the polyolefin recycling stream that is measurable using the measurement method.

In a final aspect, the present invention is directed to a use of quality control data obtained at an intermediate position of a mechanical polyolefin recycling process to adjust the process conditions of one or more constituent steps within the mechanical polyolefin recycling process for optimising the performance of the mechanical polyolefin recycling process, wherein the quality control data is any measurable mechanical, rheological or compositional property or properties of the polyolefin(s) present in a polyolefin recycling stream in the mechanical polyolefin recycling process, and
wherein optimising the performance of the mechanical polyolefin recycling process involves the improvement or one or more mechanical, rheological and/or compositional properties of the recycled polyolefin composition.

All preferred embodiments and fallback positions of the process for storing quality control data and the process for optimising the performance of the mechanical polyolefin recycling process as described above are applicable mutatis mutandis to the use of a measurement method and the use of quality control data described above.

### Measurement Methods

### Sub-Sampling of Flakes

To obtain a representative test portion for the subsequent analyses, a coning and quartering approach done according to DIN/EN 15002:2015 was applied. Within this approach, flake samples are mixed thoroughly and spread over a flat surface and coned. The sample is than quartered with a metal cross resulting in four slices with the same shape and size. The two opposite quarters are discarded and the remaining two portions are mixed thoroughly. With every coning and quartering cycle, the sample amount is divided in 2 equal portions. The previously explained steps (mixing, coning, quartering and discarding) were repeated until the required sample amount of about 120 g was obtained (e.g. for an initial sample amount of 1 kg, three cycles are needed).

### Sample Preparation of Flakes

After the sub-sampling, the flakes are cryo-milled using a centrifugal mill ZM 200 and a 1.0 mm sieve. The obtained cryo-milled material (about 120 g) is dried in a circulating air oven at 80° C. for 3 h for the following subsequent tests: MFR, frequency sweep, LAOS, DSC, FTIR, density, HPLC antioxidant (AO) and GC additives. For HS/GC/MS (HS incubation 100° C./2 h), no drying is performed. In order to properly seal and keep odorant components, flake samples for HS/GC/MS analysis where immediately packed in aluminium bags.

### Additive Analyses by HPLC

Additive analyses were performed with cryo-milled and dried flakes. A metal net approach was applied for both additive methods (HPLC antioxidants and GC additives). Information on the applied procedure and test setup are laid out in Table 1.

TABLE 1
Metal net approach applied for flexible flakes
Metal net approach

| | | |
|---|---|---|
| Method | GC additives | HPLC antioxidants |

| | |
|---|---|
| Extraction | Approximately 2.5 g of milled sample in 1 metal net |
| setup | 15 ml extraction solution |
| | 20 ml headspace vial |

| | | |
|---|---|---|
| Extraction | 99° C. for 90 min, | 95° C. for 120 min, |
| conditions | occasional shaking | occasional shaking |
| Analysis | GC analysis after filtration | HPLC analysis (after |
| | (and derivatisation, | filtration, BTM61041) |
| | BTM61001) | |

### HS-GC-MS Analysis

This analysis is used to indirectly estimate the odour relevance of selected marker substances.

The determination is based on a static headspace (HS) approach. This internal custom analysis uses a HS/GC/MS device for a relative comparison of peak areas. Due to its measurement principle, this approach is used for screening purposes only. A true quantification of substance amounts in the polyolefin matrix is not applicable.

2.000±0.050 g cryo-milled flakes or cryo-milled pellets were weighed in a 20 ml HS vial and sealed with a PTFE cap. For every sample, a double determination was performed.

The specific HS/GC/MS testing parameters applied for these tests are stated below:
HS parameter (Agilent G1888 Headspace Sampler)
   Vial equilibration time: 5 min (standard), 120 min (sample)
   Oven temperature: 200° C. (standard), 100° C. (sample)
   Loop temperature: 205° C.
   Transfer line temperature: 210° C.
   Low shaking
GC parameter (Agilent 7890A GC System)
   Column: ZB-WAX 7HG-G007-22
   (30 m×250 μm×1 μm)
   Carrier gas: Helium 5.0
   Flow: 2 ml/min
   Split: 5:1
   GC oven program: 35° C. for 0.1 min
      10° C./min until 250° C.
      250° C. for 1 min
MS parameter (Agilent 5975C inert XL MSD)
   Acquisition mode: Scan
   Scan parameters:
      Low mass: 20
      High mass: 200
      Threshold: 10
Software/Data evaluation
   MSD ChemStation E.02.02.1431
   MassHunter GC/MS Acquisition B.07.05.2479
   AMDIS GC/MS Analysis Version 2.71
   NIST/EPA/NIH Mass Spectral Library (2011 version)
   NIST Mass Spectral Search Program Version 2.0 g

Information on standard solutions used is as follows:

For a positive identification and comparison with the (lowest) odour detection thresholds (ODT), standards with the defined marker substances were created (see Table II). For standard 1 methanol was used as a solvent and for standard 2 2-butanol.

For the HS/GC/MS analysis, 5 μl of each standard were injected in separate 20 ml HS vials, sealed with a PTFE cap and measured.

At the given HS parameters, it can be assumed that all standard substances are fully vaporised. The concentration of each analyte in the HS c_{G} is listed in Table 2.

TABLE 2
Calibration standards and ODTs

| | | | Target | Odour detection |
|---|---|---|---|---|
| | Calibration | | ion | threshold / |
| Analyte | standard | c_{G} / ng ml⁻¹ | (m/z) | mg m⁻³ |
| Toluene | Standard 1 | 34 | 91 | 0.12 |
| Acetic acid | Standard 1 | 98 | 60 | 0.001 |
| Hexanal | Standard 1 | 32 | 44 | 0.0011 |
| D-Limonene | Standard 1 | 32 | 68 | 0.045 |
| Acetaldehyde | Standard 2 | 71 | 44 | 0.0027 |
| Acetone | Standard 2 | 1512 | 58 | 1 |
| tert-Butanol | Standard 2 | 83 | 59 | 10 |

For data evaluation, the following principles are considered:

The concentration of an analyte in the headspace c_{G} can be determined by considering the substance amount mg and the available headspace volume V_{G} (Equation 1).

$${c}_{G}^{Standard} = \frac{{m}_{G}^{Standard}}{{V}_{G}^{Standard}} \qquad ( 1 )$$

By integrating the extracted ion chromatogram (EIC), the peak area is obtained for every analyte. The corresponding target ions are listed in Table II. The theoretical peak area of the (lowest) ODT is then calculated using Equation 2.

$$Theoretical peak {area}^{ODT} = \frac{Peak {area}^{Standard}}{{c}_{G}^{Standard}} * ODT \qquad ( 2 )$$

To estimate the odour relevance of an analyte in the headspace above a real sample, the peak area of an analyte (sample) is compared with theoretical peak area (ODT).

Additionally, an odour activity factor was introduced (Equation 3). This factor is the fraction of the actual peak area of the analyte (sample) and the theoretical peak area at the lowest odour detection threshold found in literature [1]. A value above 1 indicates the relevance of an analyte to the odour at the given HS temperature.

$$Odour activity factor = \frac{Peak {area}^{Sample}}{Theoretica peak {area}^{ODT}} \qquad ( 3 )$$

[1] Van Gemert L. J., Odour Thresholds: Compilations of odour threshold values in air, water and other media, Utrecht, Oliemans Punter & Partners BV, 2011

### FT-IR Spectroscopy

Standard transmission FTIR measurements were done on compression moulded plaques done from cryomilled flakes and following the procedure described below. In order to ensure representativeness, tests are done on a minimum of 3 compression moulding specimens. Polyolefinic and non-polyolefinic composition is determined in a semi-quantitative or quantitative way, depending on the substance.

### Sample Preparation:

All calibration samples and samples to be analyzed are prepared in similar way, on molten pressed plates done from cryomilled powder (flakes). Around 2 to 3 g of compounds to be analyzed are molten at 190° C. Subsequently, for 20 seconds 60 to 80 bar pressure is applied in a hydraulic heating press. Next, the samples are cooled down to room temperature in 40 second in a cold press under the same pressure, in order to control the morphology of the compound. The thickness of the plates are controlled by metallic calibrated frame plates 2.5 cm by 2.5 cm, 100 to 200 μm thick (depending MFR from the sample); two plates are produced in parallel at the same moment and in the same conditions. The thickness of each plate is measured before any FTIR measurements; all plates are between 100 to 200 μm thick. To control the plate surface and to avoid any interference during the measurement, all plates are pressed between two double-sided silicone release papers. In case of powder samples or heterogeneous compounds, the pressing process would be repeated three times to increase homogeneity by pressed and cutting the sample in the same conditions as described before.

### Spectrometer:

Standard transmission FTIR spectroscope such as Bruker Vertex 70 FTIR spectrometer is used with the following set-up:
a spectral range of 4000-400 cm⁻¹,
an aperture of 6 mm,
a spectral resolution of 2 cm⁻¹,
with 16 background scans, 16 spectrum scans,
an interferogram zero filling factor of 32
Norton Beer strong apodisation.

Spectrum are recorded and analysed in Bruker Opus software.

### Calibration Samples:

As FTIR is a secondary method, several calibration standards were compounded to cover the targeted analysis range, typically from:
0.2 wt % to 2.5 wt % for PA
0.1 wt % to 5.0 wt % for PS
0.2 wt % to 2.5 wt % for PET
0.1 wt % to 4.0 wt % for PVC

The following commercial materials were used for the compounds: Borealis HC600TF as iPP, Borealis FB3450 as HDPE and for the targeted polymers such RAMAPET NIS (Indorama Polymer) for PET, Ultramid® B36LN (BASF) for Polyamide 6, Styrolution PS 486N (Ineos) for High Impact Polystyrene (HIPS), and for PVC Inovyn PVC 263B (under powder form).

All compounds are made at small scale in a Haake kneader at a temperature below 265° C. and less than 10 minutes to avoid degradation.

Additional antioxidant such as Irgafos 168 (3000 ppm) is added to minimise the degradation.

### Calibration:

The FTIR calibration principal is the same for all the components: the intensity of a specific FTIR band divided by the plate thickness is correlated to the amount of component determined by 1H or 13C solution state NMR on the same plate.

Each specific FTIR absorption band is chosen due to its intensity increase with the amount of the component concentration and due to its isolation from the rest of the peaks, whatever the composition of the calibration standard and real samples.

This methodology is described in the publication from Signoret and al. “Alterations of plastic in MIR and the potential impacts on identification towards recycling”, Resources, conservation and Recycling journal, 2020, volume 161, article 104980.

The wavelength for each calibration band is:
3300 cm-1 for PA, 1601 cm-1 for PS, 1410 cm-1 for PET, 615 cm-1 for PVC, 1167 cm-1 for iPP.

For each polymer component i, a linear calibration (based on linearity of Beer-Lambert law) is constructed. A typical linear correlation used for such calibrations is given below:

$${x}_{i} = {A}_{i} \cdot \frac{{E}_{i}}{d} + {B}_{i}$$

where xi is the fraction amount of the polymer component i (in wt %), Ei is the absorbance intensity of the specific band related to the polymer component i (in a.u. absorbance unit).

These specific bands are,
3300 cm⁻¹ for PA
1601 cm⁻¹ for PS
1410 cm⁻¹ for PET
615 cm⁻¹ for PVC
1167 cm⁻¹ for iPP
d is the thickness of the sample plate
Ai and Bi are two coefficients of correlation determined for each calibration curve

No specific isolated band can be found for C2 rich fraction and as a consequence the C2 rich fraction is estimated indirectly,

$${x}_{C 2 rich} = 100 - ( {x}_{iPP} + {x}_{PA} + {x}_{PS} + {x}_{PET} + {x}_{EVA} + {x}_{PVC} + {x}_{chalk} + {x}_{talc} )$$

The EVA, Chalk and Talc contents are estimated “semi-quantitatively”. Hence, this renders the C2 rich content “semi-quantitative”.

In addition, the presence of titanium di-oxide, TiO2 and Carbon Black are reported. Their quantifications are not feasible with FTIR.

For each calibration standard, wherever available, the amount of each component is determined by either ¹H or ¹³C solution state NMR, as primary method (except for PA). The NMR measurements are performed on the exact same FTIR plates used for the construction of the FTIR calibration curves.

### Temperature Modulated Differential Scanning Calorimetry

Temperature Modulated Differential Scanning calorimetry (TM-DSC) experiments were run on a TA Instruments Q2000 device calibrated with Indium, Zinc, and Tin according to ISO 11357/1. The measurements were run under nitrogen atmosphere (50 mL min-1) on 5±1 mg samples in a heat/cool/heat cycle with a scan rate of 10° C./min between −30° C. and 225° C. according to ISO 11357/3 for the first heating run and the cooling run. The second heating run was performed in a modulated fashion, in particular modulating the temperature of 0.32° C. every 60 seconds while heating the sample at 2° C./min. The non-reversible heat flow was in particular analysed. Integrating it between 50° C. and 140° C. quantifies the relative content of PE in the recyclate, where each peak detected is additionally attributed to a different PE fraction. In particular integrating as a “perpendicular drop” till 115° C. characterizes the content of LDPE in the blend.

### Ash Content by TGA

Thermogravimetric Analysis (TGA) experiments were performed with a Perkin Elmer TGA 8000. Approximately 10-20 mg of materials were placed in a platinum pan. The temperature was equilibrated at 50° C. for 10 minutes, and afterwards raised to 950° C. under nitrogen at 20° C./min. The ash content was evaluated as the weight % at 850° C.

### MFR (Melt Flow Rate)

The melt flow rate (MFR) is determined according to ISO 1133-Determination of the melt mass-flow rate (MFR) and melt volume-flow rate (MVR) of thermoplastics—Part 1:

Standard method and is indicated in g/10 min.

The MFR is an indication of the flowability, and hence the processability, of the polymer.

The higher the melt flow rate, the lower the viscosity of the polymer.

The MFR₂ of polypropylene is determined at a temperature of 230° C. and a load of 2.16 kg.

The MFR₂ of polyethylene is determined at a temperature of 190° C. and a load of 2.16 kg.

Measurements were done on cryomilled flakes.

### Frequency Sweep (Dynamic Rheology) Measurements

The characterisation of polymer melts by dynamic shear measurements complies with ISO standards 6721-1 and 6721-10. The measurements were performed on an Anton Paar MCR501 stress controlled rotational rheometer, equipped with a 25 mm parallel plate geometry. Measurements were undertaken on compression moulded plates, using nitrogen atmosphere and setting a strain within the linear viscoelastic regime. The oscillatory shear tests were done at 190° C. and 200° C. for PE and PP respectively applying a frequency range between 0.01 and 600 rad/s and setting a gap of 1.3 mm.

In a dynamic shear experiment the probe is subjected to a homogeneous deformation at a sinusoidal varying shear strain or shear stress (strain and stress controlled mode, respectively). On a controlled strain experiment, the probe is subjected to a sinusoidal strain that can be expressed by

$$γ ( t ) = {γ}_{0} sin ( ω t ) \qquad ( 1 )$$

If the applied strain is within the linear viscoelastic regime, the resulting sinusoidal stress response can be given by

$$σ ( t ) = {σ}_{0} sin ( ω t + δ ) \qquad ( 2 )$$

where
σ₀ and γ₀ are the stress and strain amplitudes, respectively
ω is the angular frequency
δ is the phase shift (loss angle between applied strain and stress response)
t is the time

Dynamic test results are typically expressed by means of several different rheological functions, namely the shear storage modulus G′, the shear loss modulus, G″, the complex shear modulus, G*, the complex shear viscosity, η*, the dynamic shear viscosity, η′, the out-of-phase component of the complex shear viscosity η″ and the loss tangent, tan δ which can be expressed as follows:

$${G}^{′} = \frac{{σ}_{0}}{{γ}_{0}} cos δ [ Pa ] \qquad ( 3 )$$

$${G}^{′} = \frac{{σ}_{0}}{{γ}_{0}} sin δ [ Pa ] \qquad ( 4 )$$

$${G}^{*} = {G}^{′} + {iG}^{″} [ Pa ] \qquad ( 5 )$$

$${η}^{*} = {η}^{′} - i {η}^{″} [ Pa \cdot s ] \qquad ( 6 )$$

$${η}^{′} = \frac{{G}^{″}}{ω} [ Pa \cdot s ] \qquad ( 7 )$$

$${η}^{″} = \frac{{G}^{′}}{ω} [ Pa \cdot s ] \qquad ( 8 )$$

The determination of so-called Shear Thinning Factor (STF) is done, as described in equation 13.

$$STF = \frac{{Eta}^{*} for ( ω = 0.05 rad / s )}{{Eta}^{*} for ( ω = 300 rad / s )} [ ] \qquad ( 13 )$$

The determination of the polydispersity index (PI) is done as described in equation 14.

$$PI = \frac{1 {0}^{5}}{Gc} [ ] . \qquad ( 14 )$$

where Gc is the cross over modulus, that can be described as the value of the shear storage modulus, G′, when the shear storage modulus G′ is equal to the shear loss modulus G″. The frequency at which G′ equals de value of G″ is defined as cross over frequency (ω_{C}).

The values are determined by means of a single point interpolation procedure, as defined by Rheoplus software. In situations for which a given G* value is not experimentally reached, the value is determined by means of an extrapolation, using the same procedure as before. In both cases (interpolation or extrapolation), the option from Rheoplus “—Interpolate y-values to x-values from parameter” and the “logarithmic interpolation type” were applied. These tests were done on compression molded discs done with cryomilled powder.

### LAOS (Strain Sweep, Dynamic Rheology)

The investigation of the non-linear viscoelastic behavior under shear flow was done resorting to Large Amplitude Oscillatory Shear. The method requires the application of a sinusoidal strain amplitude, γ₀, imposed at a given angular frequency, ω, for a given time, t. Provided that the applied sinusoidal strain is high enough, a non-linear response is generated. The stress, σ is in this case a function of the applied strain amplitude, time and the angular frequency. Under these conditions, the non-linear stress response is still a periodic function; however, it can no longer be expressed by a single harmonic sinusoid. The stress resulting from a non-linear viscoelastic response [0-0] can be expressed by a Fourier series, which includes the higher harmonics contributions:

$$σ ( t , ω , {γ}_{0} ) = {γ}_{0} \cdot {\sum }_{n} [ {G}_{n}^{′} ( ω , {γ}_{0} ) \cdot sin ( n ω t ) + {G}_{n}^{″} ( ω , {γ}_{0} ) \cdot cos ( n ω t ) ]$$

with,
σ—stress response
t—time
ω—frequency
γ₀—strain amplitude
n—harmonic number
G′ₙ—n order elastic Fourier coefficient
G″ₙ—n order viscous Fourier coefficient

The non-linear viscoelastic response was analysed applying Large Amplitude Oscillatory Shear (LAOS) [4-6]. Time sweep measurements were undertaken on an RPA 2000 rheometer from Alpha Technologies coupled with a standard biconical die. During the course of the measurement the test chamber is sealed and a pressure of about 6 MPa is applied. The LAOS test is done applying a temperature of 190° C., an angular frequency of 0.628 rad/s and a strain of 1000%. In order to ensure that steady state conditions are reached, the non-linear response is only determined after at least 20 cycles per measurement are completed. The Large Amplitude Oscillatory Shear Non-Linear Factor (LAOS_NLF) is defined by:

$${LAOS}_{NLF} ( 1000 \% ) = \vert \frac{{G}_{1}^{′}}{{G}_{3}^{′}} \vert$$

where G′₁—first order Fourier Coefficient
   G′₃—third order Fourier Coefficient

These tests were done on cryomilled powder.
[1] J. M. Dealy, K. F. Wissbrun, Melt Rheology and Its Role in Plastics Processing: Theory and Applications; edited by Van Nostrand Reinhold, New York (1990)
[2] S. Filipe, Non-Linear Rheology of Polymer Melts, AIP Conference Proceedings 1152, pp. 168-174 (2009)
[3] M. Wilhelm, Macromol. Mat. Eng. 287, 83-105 (2002)
[4] S. Filipe, K. Hofstadler, K. Klimke, A. T. Tran, Non-Linear Rheological Parameters for Characterisation of Molecular Structural Properties in Polyolefins, Proceedings of Annual European Rheology Conference, 135 (2010)
[5] S. Filipe, K. Klimke, A. T. Tran, J. Reussner, Proceedings of Novel Non-Linear Rheological Parameters for Molecular Structural Characterisation of Polyolefins, Novel Trends in Rheology IV, Zlin, Check Republik (2011)
[6] K. Klimke, S. Filipe, A. T. Tran, Non-linear rheological parameters for characterization of molecular structural properties in polyolefins, Proceedings of European Polymer Conference, Granada, Spain (2011)

### Uniaxial Extensional Viscosity, SER

The uniaxial extensional viscosity, η_{E}⁺ (t, \dot{ε}) was obtained from uniaxial extensional flow measurements, conducted on an Anton Paar MCR 501 coupled with the Sentmanat extensional fixture (SER-1). The temperature for the uniaxial extensional flow measurements was set at 180° C., applying extension rates ranging from 0.3 s⁻¹ to 10 s⁻¹. Particularly care was taken for the preparation of the samples for extensional flow. The samples were prepared by compression moulding of the cryomilled powder at 230° C. followed by slow cooling to room temperature (forced water or air cooling were not used). This procedure allowed obtaining well shaped samples free of residual stresses. The sample was left for some minutes at the testing temperature to ensure thermal stability, before carrying out the uniaxial extensional flow measurements. The sample' dimensions were fixed: 18 mm length, 10 mm width and 0.6 mm thickness.

### XRF

The instrument used for the XRF measurements was a wavelength dispersive device called Zetium (2.4 kW) from Malvern Panalytical. The instrument was calibrated with polyolefin based standard sets from Malvern Panalytical. The method is used to determine the quantitative content of F, Na, Mg, Al, Si, P, S, Ca, Ti, Zn, Cr, Cd, Hg, Pb, As, Ni, Cu, Ba, Br, Cl, Sb, Sn in polyolefin matrix within defined ranges of these standards. The analysis are done under vacuum on a plaque with a diameter of 40 mm and a thickness of 2 mm. Elements which are not covered by a standard, or the content is outside of the calibrated standard range, are then analyzed with a semi-quantitative mode (Omnian). The semi-quantitative mode covers the elements Be—U.

The samples tested included compression molded discs done from cryomilled powder.

### CIELAB

The method is used for measurement of colour on flakes and complies with ISO 11664-4. With a spectrophotometer, the 3 standard colour value values X, Y and Z are measured, which are used to calculate the CIE L*, a*, b* and its colour distances.

Laser Spectroscopy (e.g. Raman Spectroscopy)

Last spectroscopy is a collective term for different spectroscopic methods that involve the interaction of a laser beam with matter. In particular, Raman spectroscopy, a vibrational spectroscopy method for chemical substances, absorption spectroscopy involving quantum cascade lasers (QCLs) in the IR spectral range, as well as laser-induced breakdown spectroscopy (LIBS) where a laser evaporates matter, and the emitted light from the generated plasma is detected.

Laser/Raman spectrometers are well known in the art and it is not important which of the many commercial spectrometers are used in the context of the present invention. Furthermore, the precise experimental setup can be suitably determined by the person skilled in the art, based on known procedures, depending on precisely which property is being measured.

1. A process for collecting and storing quality control data of a polyolefin recycling stream at one or more intermediate positions of a mechanical polyolefin recycling process, wherein the quality control data is any measurable mechanical, rheological or compositional property or properties of the polyolefin(s) present in the polyolefin recycling stream that is collected via a method selected from the group consisting of headspace-gas chromatography-mass spectrometry (HS-GC-MS), high pressure liquid chromatography (HPLC), temperature modulated differential scanning calorimetry (TM-DSC), thermogravimetric analysis of ash content (TGA), dynamic rheology measurement via frequency sweep analysis, large amplitude oscillatory shear (LAOS) measurements, uniaxial extensional flow measurements (SER), X-ray fluorescence measurements (XRF), laser spectroscopy, Raman spectroscopy, CIELAB spectrophotometric measurements, and combinations thereof.

2. The process according to claim 1, wherein the quality control data is collected at two or more intermediate positions.

3. The process according to claim 1, wherein at least one of the one or more intermediate positions of the mechanical polyolefin recycling process is at an intermediate position other than during a sorting step.

4. A process for optimising the performance of a mechanical polyolefin recycling process, wherein the process comprises a step of adjusting the process conditions of one or more constituent steps within the mechanical polyolefin recycling process in response to quality control data measured on a polyolefin recycling stream at one or more intermediate positions of the mechanical polyolefin recycling process, wherein the quality control data is any measurable mechanical, rheological or compositional property or properties of the polyolefin(s) present in the polyolefin recycling stream, and wherein optimising the performance of the mechanical polyolefin recycling process involves the improvement of one or more mechanical, rheological and/or compositional properties of the recycled polyolefin composition.

5. The process according to claim 4, wherein at least one of the one or more constituent steps of the step of adjusting the process conditions of one or more constituent steps within the mechanical polyolefin recycling process is a constituent step upstream from the intermediate position from which the quality control data has been measured.

6. The process according to claim 4, wherein at least one of the one or more constituent steps of the step of adjusting the process conditions of one or more constituent steps within the mechanical polyolefin recycling process is a constituent step downstream from the intermediate position from which the quality control data has been measured.

7. The process according to claim 1, wherein the polyolefin being measured in the recycling stream is in flaked form.

8. The process according to claim 1, wherein the measurement of the quality control data is conducted on-line.

9. The process according to claim 1, wherein the measurement of the quality control data is conducted off-line.

10. The process according to claim 1, wherein the mechanical polyolefin recycling process comprises, in the given order, the steps of:
a) providing a precursor mixed plastic recycling stream (A);
b) sieving the precursor mixed plastic recycling stream (A) to create a sieved mixed plastic recycling stream (B) having only articles with a longest dimension in the range from 30 to 400 mm;
c) sorting the sieved mixed plastic recycling stream (B) by means of one or more optical sorters wherein the sieved mixed plastic recycling stream (B) is a least sorted by colour and optionally also by polyolefin type and/or article form, thereby generating a single-colour sorted polyolefin recycling stream (C);
d) reducing the size of the pieces of the single-colour sorted polyolefin recycling stream (C) to form a flaked polyolefin recycling stream (D);
e) washing the flaked polyolefin recycling stream (D) with a first aqueous washing solution (W1) without the input of thermal energy, thereby generating a first suspended polyolefin recycling stream (E);
f) removing the first aqueous washing solution (W1) from the first suspended polyolefin recycling stream (E) to obtain a first washed polyolefin recycling stream (F);
g) washing the first washed polyolefin recycling stream (F) with a second aqueous washing solution (W2) thereby generating a second suspended polyolefin recycling stream (G), wherein sufficient thermal energy is input to the system to raise the temperature to a temperature in the range from 65 to 95° C. during the washing;
h) removing the second aqueous washing solution (W2) and any material not floating on the surface of the second aqueous washing solution from the second suspended polyolefin recycling stream (G) to obtain a second washed polyolefin recycling stream (H);
i) drying the second washed polyolefin recycling stream (H), thereby obtaining a dried polyolefin recycling stream (I);
j) optionally separating the dried polyolefin recycling stream (I) into a light fraction and a heavy fraction polyolefin recycling stream (J);
k) further sorting the heavy fraction polyolefin recycling stream (J) or, in the case that step j) is absent, the dried polyolefin recycling stream (I) by means of one or more optical sorters to remove any flakes containing material other than the target polyolefin, yielding a purified polyolefin recycling stream (K);
l) optionally melt extruding the purified polyolefin recycling stream (K) to form an extruded recycled polyolefin product (L); and
m) optionally aerating the recycled polyolefin product (L) or, in the case that step l) is absent, the purified polyolefin recycling stream (K) to remove volatile organic compounds, thereby generating an aerated recycled polyolefin product (M), being either an aerated extruded recycled polyolefin product (M1) or aerated recycled polyolefin flakes (M2),
wherein the order of steps l) and m) can be interchanged, such that the purified polyolefin recycling stream (K) is first aerated to form aerated recycled polyolefin flakes (M2) that are subsequently extruded to form an extruded aerated recycled polyolefin product (M3), and
wherein the one or more intermediate positions of the recycling stream are selected from the group consisting of between steps b) and c), between steps c) and d), between steps d) and e), between steps e) and f), between steps f) and g), between steps g) and h), between steps h) and i), between steps i) and j) and between steps j) and k) if j) is present or between steps i) and k) if j) is not present, and, when the relevant steps are present, between steps k) and l), steps k) and m), steps l) and m) and steps m) and l).

11. The process according to claim 1, wherein the process further comprises the step of providing an adjustment control model configured to adjust the process conditions of the one or more constituent steps at least based on the measured quality control data.

12. A computer-implemented method for providing training data for an adjustment control model configured to adjust the process conditions of one or more constituent steps of a mechanical polyolefin recycling process at least based on the measured quality control data in a process according to claim 1, comprising the steps:
providing quality control data of the process according to claim 1;
providing adjustment data corresponding to an adjustment of the process conditions in view of the provided quality control data;
labelling the quality control data with the adjustment data.

13. An adjustment control model at least trained with training data provided according to claim 12.

14. (canceled)

15. (canceled)

16. The process according to claim 1, wherein all of the one or more intermediate positions of the mechanical polyolefin recycling process are at intermediate positions other than during a sorting step.

17. The process according to claim 4, wherein the polyolefin being measured in the recycling stream is in flaked form.

18. The process according to claim 4, wherein the measurement of the quality control data is conducted on-line.

19. The process according to claim 4, wherein the measurement of the quality control data is conducted off-line.

20. The process according to claim 4, wherein the mechanical polyolefin recycling process comprises, in the given order, the steps of:
a) providing a precursor mixed plastic recycling stream (A);
b) sieving the precursor mixed plastic recycling stream (A) to create a sieved mixed plastic recycling stream (B) having only articles with a longest dimension in the range from 30 to 400 mm;
c) sorting the sieved mixed plastic recycling stream (B) by means of one or more optical sorters wherein the sieved mixed plastic recycling stream (B) is a least sorted by colour and optionally also by polyolefin type and/or article form, thereby generating a single-colour sorted polyolefin recycling stream (C);
d) reducing the size of the pieces of the single-colour sorted polyolefin recycling stream (C) to form a flaked polyolefin recycling stream (D);
e) washing the flaked polyolefin recycling stream (D) with a first aqueous washing solution (W1) without the input of thermal energy, thereby generating a first suspended polyolefin recycling stream (E);
f) removing the first aqueous washing solution (W1) from the first suspended polyolefin recycling stream (E) to obtain a first washed polyolefin recycling stream (F);
g) washing the first washed polyolefin recycling stream (F) with a second aqueous washing solution (W2) thereby generating a second suspended polyolefin recycling stream (G), wherein sufficient thermal energy is input to the system to raise the temperature to a temperature in the range from 65 to 95° C. during the washing;
h) removing the second aqueous washing solution (W2) and any material not floating on the surface of the second aqueous washing solution from the second suspended polyolefin recycling stream (G) to obtain a second washed polyolefin recycling stream (H);
i) drying the second washed polyolefin recycling stream (H), thereby obtaining a dried polyolefin recycling stream (I);
j) optionally separating the dried polyolefin recycling stream (I) into a light fraction and a heavy fraction polyolefin recycling stream (J);
k) further sorting the heavy fraction polyolefin recycling stream (J) or, in the case that step j) is absent, the dried polyolefin recycling stream (I) by means of one or more optical sorters to remove any flakes containing material other than the target polyolefin, yielding a purified polyolefin recycling stream (K);
l) optionally melt extruding the purified polyolefin recycling stream (K) to form an extruded recycled polyolefin product (L); and
m) optionally aerating the recycled polyolefin product (L) or, in the case that step l) is absent, the purified polyolefin recycling stream (K) to remove volatile organic compounds, thereby generating an aerated recycled polyolefin product (M), being either an aerated extruded recycled polyolefin product (M1) or aerated recycled polyolefin flakes (M2),
wherein the order of steps l) and m) can be interchanged, such that the purified polyolefin recycling stream (K) is first aerated to form aerated recycled polyolefin flakes (M2) that are subsequently extruded to form an extruded aerated recycled polyolefin product (M3), and
wherein the one or more intermediate positions of the recycling stream are selected from the group consisting of between steps b) and c), between steps c) and d), between steps d) and e), between steps e) and f), between steps f) and g), between steps g) and h), between steps h) and i), between steps i) and j) and between steps j) and k) if j) is present or between steps i) and k) if j) is not present, and, when the relevant steps are present, between steps k) and l), steps k) and m), steps l) and m) and steps m) and l).

21. The process according to claim 4, wherein the process further comprises the step of providing an adjustment control model configured to adjust the process conditions of the one or more constituent steps at least based on the measured quality control data.
